(19) United States
(12) Patent Application Publication
(10) Pub. No.: US 2013/0060418 A1
(43) Pub. Date: Mar. 7, 2013

(54) ELECTRONIC CONTROL UNIT

(71) Applicants: Syunsuke NOMURA, Kariya-city (JP); Masayoshi KONDOH, Chiryu-city (JP); Hirokazu WATANABE, Chiryu-city (JP)

(72) Inventors: Syunsuke NOMURA, Kariya-city (JP); Masayoshi KONDOH, Chiryu-city (JP); Hirokazu WATANABE, Chiryu-city (JP)

(73) Assignee: DENSO CORPORATION, Kariya-city (JP)

(21) Appl. No.: 13/604,649

(22) Filed: Sep. 6, 2012

(30) Foreign Application Priority Data
Sep. 7, 2011 (JP) 2011-195262

(51) Int. Cl. G06F 19/00

(52) U.S. Cl. 701/33.4

(57) ABSTRACT

An electronic control unit includes an abnormality detecting section, a storage portion, a simplifying section, and a storing section. The abnormality detecting section detects an occurrence of a vehicle abnormality. The storage portion stores driving information of a vehicle. The simplifying section simplifies time-series data values of the driving information before the occurrence of the vehicle abnormality by reducing an accuracy of the time-series data values of the driving information and does not simplify a data value of the driving information at the occurrence of the vehicle abnormality. The storing section stores the data value of the driving information at the occurrence of the vehicle abnormality, which is not simplified by the simplifying section, and the time-series data values of the driving information before the occurrence of the vehicle abnormality, which are simplified by the simplifying section, in the storage portion.

### CROSS REFERENCE TO RELATED APPLICATIONS

The present application is based on and claims priority to Japanese Patent Application No. 2011-195262 filed on Sep. 7, 2011, the contents of which are incorporated in their entirety herein by reference.

### TECHNICAL FIELD

The present disclosure relates to an electronic control unit that stores driving information of a vehicle to analyze a cause of a vehicle abnormality.

### BACKGROUND

Conventionally, when an abnormality in vehicle occurs, that is, when an abnormality occurs in sensors and an actuator disposed in a vehicle or when a vehicle behaves abnormally, time-series output signals of the sensors and time-series control data before and after the abnormality occurs are stored as driving information.

However, in cases where the output signals of the sensors and the control data having original data length are stored in chronological order, the amount of stored data may be huge. Japanese Patent No. 3,309,437 (corresponding to U.S. Pat. No. 5,590,040) discloses a self-diagnosis apparatus that determines regions to which diagnosis data input with a fixed period for analyzing an abnormality in instruments mounted in a vehicle belong, and stores a count value for each region. Accordingly, the amount of stored data can be reduced compared with cases where actual data is stored.

The self-diagnosis apparatus can analyze a frequency of diagnosis data in each region by counting the number of times the diagnosis data is generated in each region. However, the self-diagnosis apparatus cannot analyze how a vehicle abnormality occurs based on time change in driving information of the vehicle.

### SUMMARY

It is an object of the present disclosure to provide an electronic control unit that stores driving information of a vehicle to analyze a cause of a vehicle abnormality and that can reduce the amount of stored data.

An electronic control unit according to an aspect of the present disclosure includes an abnormality detecting section, a storage portion, a simplifying section, and a storing section. The abnormality detecting section detects an occurrence of a vehicle abnormality. The storage portion stores driving information of a vehicle. The simplifying section simplifies time-series data values of the driving information before the occurrence of the vehicle abnormality by reducing an accuracy of the time-series data values of the driving information and does not simplify a data value of the driving information at the occurrence of the vehicle abnormality. The storing section stores the data value of the driving information at the occurrence of the vehicle abnormality, which is not simplified by the simplifying section, and the time-series data values of the driving information before the occurrence of the vehicle abnormality, which are simplified by the simplifying section, in the storage portion.

The electronic control unit simplifies the driving information except at the occurrence of the vehicle abnormality. Thus, the amount of data stored in the storage portion can be reduced.

### BRIEF DESCRIPTION OF THE DRAWINGS

Additional objects and advantages of the present disclosure will be more readily apparent from the following detailed description when taken together with the accompanying drawings. In the drawings:

FIG. 1 a block diagram showing an electronic control unit according to an embodiment of the present disclosure;

FIG. 2A is a diagram showing driving information before simplification and FIG. 2B is a diagram showing driving information after simplification;

FIG. 3A is a diagram showing an exemplary way of storing simplified driving information and FIG. 3B is a diagram showing another exemplary way of storing simplified driving information;

FIG. 4 is a diagram for explaining a simplification of an accelerator opening degree;

FIG. 5 is a diagram for explaining a simplification of an engine speed;

FIG. 6 is a diagram for explaining a simplification of a water temperature;

FIG. 7 is a flowchart showing a first example of a driving information storing process at a normal processing time;

FIG. 8 is a flowchart showing a first example of a driving information storing process at an occurrence of a vehicle abnormality;

FIG. 9 is a flowchart showing a second example of a driving information storing process at a normal processing time; and

FIG. 10 is a flowchart showing a second example of a driving information storing process at an occurrence of a vehicle abnormality;

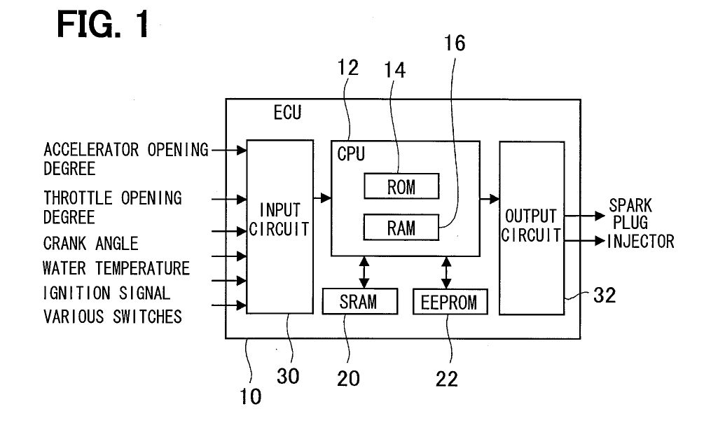

### DETAILED DESCRIPTION

Embodiments of the present disclosure will be described with reference to the accompanying drawings. An electronic control unit (ECU) 10 according to an embodiment of the present disclosure is disposed in a vehicle.

The ECU 10 may be an engine ECU that performs an injection control of an injector and an ignition control of a spark plug. The ECU 10 includes a central processing unit (CPU) 12, a standby random access memory (SRAM) 20, an electrically erasable programmable read-only memory (EEPROM) 22, an input circuit 30, and an output circuit 32.

The CPU 12 includes a read only memory (ROM) 14 and a random access memory (RAM) 16. The CPU 12 executes a control program stored in the ROM 14 and receives detection signals that indicate a driving state of the vehicle, such as an accelerator opening degree, a throttle opening degree, a crank angle, a water temperature, and an ignition signal from various sensors and various switches via the input circuit 30. Based on the detection signals, the ECU 10 outputs control signals for the injection control of the injector and the ignition control of the spark plug from the output circuit 32.

The control program of the ECU 10 uses the RAM 16 for operation, and data stored in the RAM 16 is erased when the ignition switch is turned off and a power supply to the RAM 16 is cut. Unlike the RAM 16, the SRAM 20 is supplied with electric power from a battery regardless of an on-off state of the ignition switch. Thus, the SRAM 20 may be referred to as a storage portion that stores data unless a power supply is cut due to, for example, an exchange of the battery.

The EEPROM 22 is a rewritable non-volatile storage portion. Even when a power supply from the battery is cut, the EEPROM 22 keeps the data stored therein.

Next, operations performed by the ECU 10 when the CPU 12 executes the control program stored in the ROM 14 will be described. The ECU 10 includes an abnormality detection section, a simplifying section, and a storing section.

The ECU 10 has a predetermined detection condition such as “an engine speed exceeds a predetermined value while the vehicle is in park even through an accelerator pedal is not pressed on.” The abnormality detection section in the ECU 10 determines whether a vehicle abnormality satisfying the detection condition occurs based on the detection signals from the sensors. The above-described vehicle abnormality does not occur in a normal driving operation.

The abnormality detection section in the ECU 10 may also detect abnormalities of the sensors and an actuator as vehicle abnormalities. The abnormality detection section in the ECU 10 may also detect a vehicle abnormality when an occupant of the vehicle recognizes an occurrence of the vehicle abnormality and operates a switch and the like.

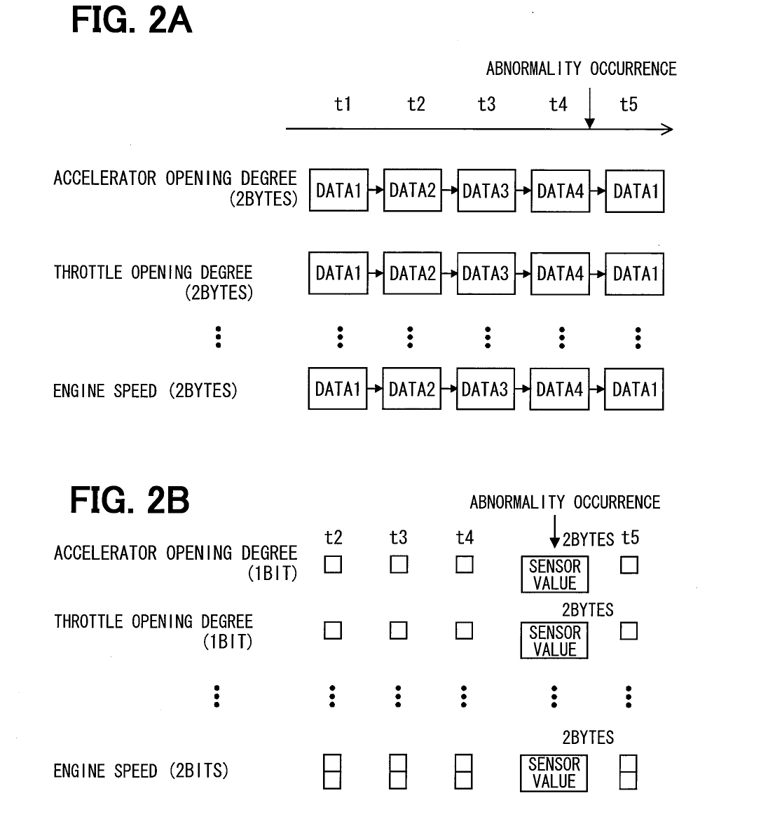

The storing section in the ECU 10 stores predetermined driving information of the vehicle in the RAM 16 at predetermined intervals, for example, 500 ms. The storing section in the ECU 10 may store simplified data value of the driving information while reducing accuracy of the data value, or the storing section in the ECU 10 may store the data values of the driving information without simplification. The simplification of the driving information will be described later. For example, a original data length of the data values of the driving information before simplification may be 2 bytes as shown in FIG. 2A.

The driving information includes a plurality of information items. The information items include the accelerator opening degree, the throttle opening degree, a shift position of a transmission, the water temperature, an intake air amount, an intake air temperature, an engine speed, and control amounts, such as a command injection amount for the injector and an ignition timing for the spark plug.

In the present embodiment, the above-described driving information is 1-entry. Time-series data values of the driving information except at an occurrence of a vehicle abnormality is stored in the RAM 16 in a 4-entry ring buffer format. When the vehicle abnormality occurs, the ECU 10 stores 3-entry driving information before the occurrence of the vehicle abnormality and 1-entry driving information after the occurrence of the vehicle abnormality with the driving information at the occurrence of the vehicle abnormality in the EEPROM 22. The vehicle information at the occurrence of the vehicle abnormality is not simplified.

In cases where the data values of the driving information stored in the RAM 16 are simplified, the data value of the driving information stored in the RAM 16 are stored in the EEPROM 22 without changing. In cases where the data values of the driving information stored in the RAM 16 are not simplified, the data values of the driving information are stored in the EEPROM 22 after simplification. Thus, the EEPROM 22 stores the driving information having a data length shown in FIG. 2B except at the occurrence of the vehicle abnormality.

Because the data values of the driving information are stored in the EEPROM 22, even when the ignition switch is turned off and driving of the vehicle stops, the data value of the driving information at the occurrence of the vehicle abnormality and the time-series data values of the driving information except at the occurrence of the vehicle abnormality, which are stored in the EEPROM 22, can be read out with a diagnosis tool. Accordingly, with respect to the driving information at the occurrence of the vehicle abnormality, a time change in the driving information except at the occurrence of the vehicle abnormality can be reproduced within a range of an accuracy of the simplified data.

Thus, the ECU 10 can analyze the cause of the vehicle abnormality based on the driving information at the occurrence of the vehicle abnormality, which is not simplified, and the time change in the driving information except at the occurrence of the vehicle abnormality with respect to the driving information at the occurrence of the vehicle abnormality.

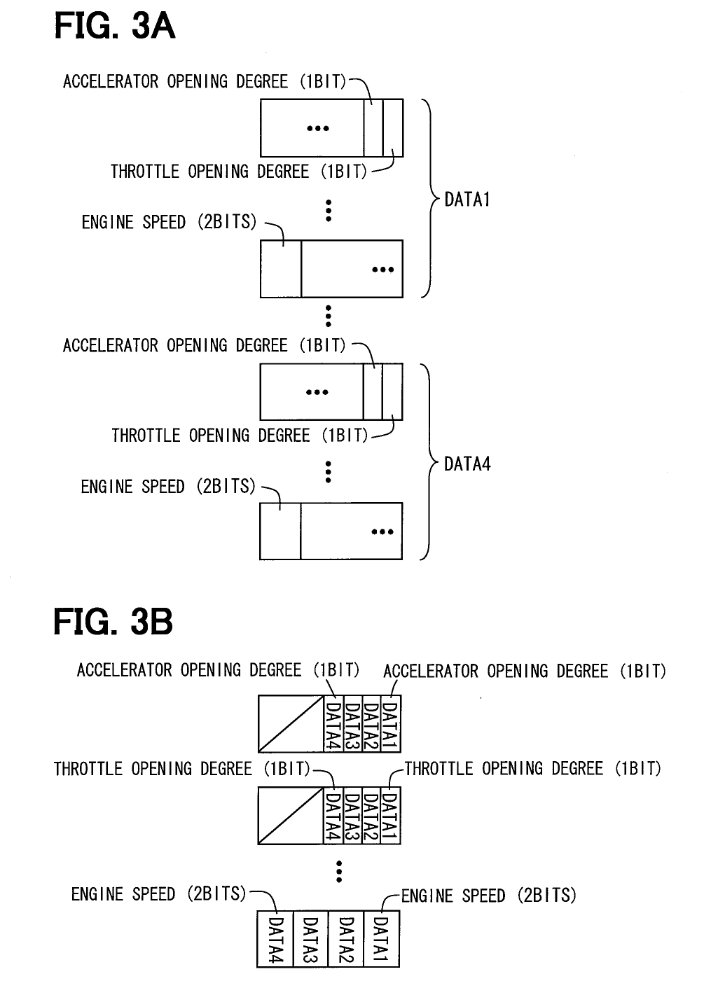

Data formats for storing the 4-entry simplified data values of the driving information except at the occurrence of the vehicle abnormality will be described with reference to FIG. 3A and FIG. 3B. In an example shown in FIG. 3A, the data values of the accelerator opening degree, the throttle opening degree, the engine speed and the like having simplified bit lengths are stored as a group for each DATA X (X=1, 2, 3, 4) of each entry of the driving information.

In an example shown in FIG. 3B, the data values of the accelerator opening degree, the throttle opening degree, the engine speed and the like having simplified bit lengths are stored for each information item.

When a vehicle abnormality occurs, it is desired to reproduce how the driving information except at the occurrence of the vehicle abnormality changes with respect to the driving information at the occurrence of the vehicle abnormality. Thus, the driving information at the occurrence of the vehicle abnormality is stored in an original data length without reducing the accuracy of the data value.

On the other hand, the simplifying section in the ECU 10 simplifies the data value of the driving information except at the occurrence of the vehicle abnormality by reducing the accuracy as shown in FIG. 2B because it is enough to know how the driving information change on a time axis with respect to the driving information at the occurrence of the vehicle abnormality. For example, the accelerator opening degree and the throttle opening degree may be expressed using 1 bit and the engine speed may be expressed using 2 bits.

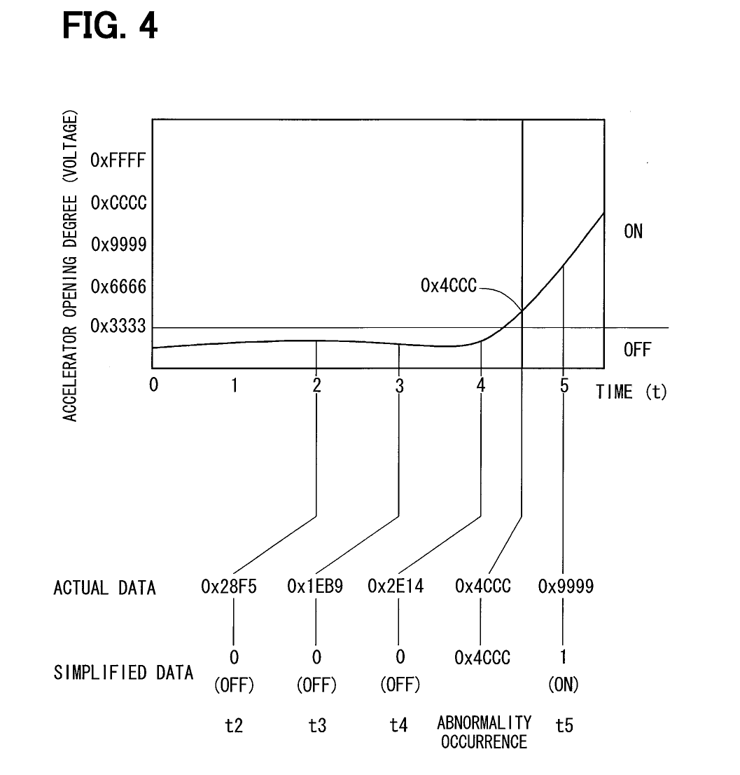

The simplifying section in the ECU 10 divides the time-series data values of the accelerator opening degree into two regions by a predetermined threshold value. For example, as shown in FIG. 4, the predetermined threshold value may be 0x3333 as an output voltage of an accelerator sensor. Thus, the ECU 10 can determine whether the accelerator pedal is pressed by expressing a region where each of the data values of the accelerator opening degree belongs as 0 (OFF) or 1 (ON) of 1 bit.

The change in the accelerator opening degree on the time axis at the occurrence of the vehicle abnormality can be reproduced based on the original (non-simplified) data value at the occurrence of the vehicle abnormality and the simplified data values before and after the occurrence of the vehicle abnormality. Thus, a detailed data value of the accelerator opening degree except at the occurrence of the vehicle abnormality is not necessary.

The simplifying section in the ECU 10 divides the time-series data values of the throttle opening degree into two regions by a predetermined threshold value in a manner similar to the accelerator opening degree. The ECU 10 can determine whether the throttle opens more than a predetermined opening degree or not by expressing a region where each of the data values of the throttle opening degree belongs as 0 or 1 of 1 bit.

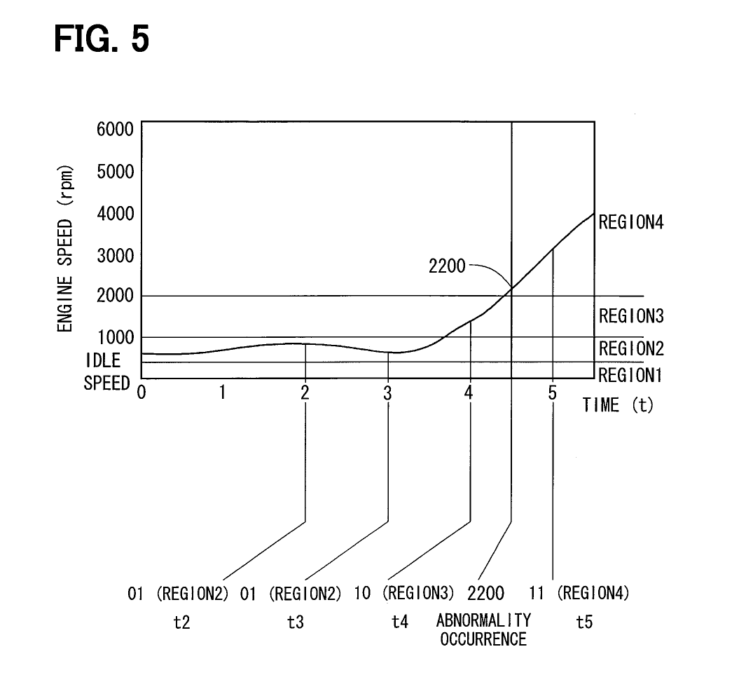

As shown in FIG. 5, the simplifying section in the ECU 10 divides time-series data values of the engine speed into four regions by setting threshold values at an idle speed, 1000 rpm, and 2000 rpm. By expressing the region where each of the time-series data values belongs using 2 bits, a change in the engine speed on the time axis including the engine speed at the occurrence of the vehicle abnormality can be reproduced.

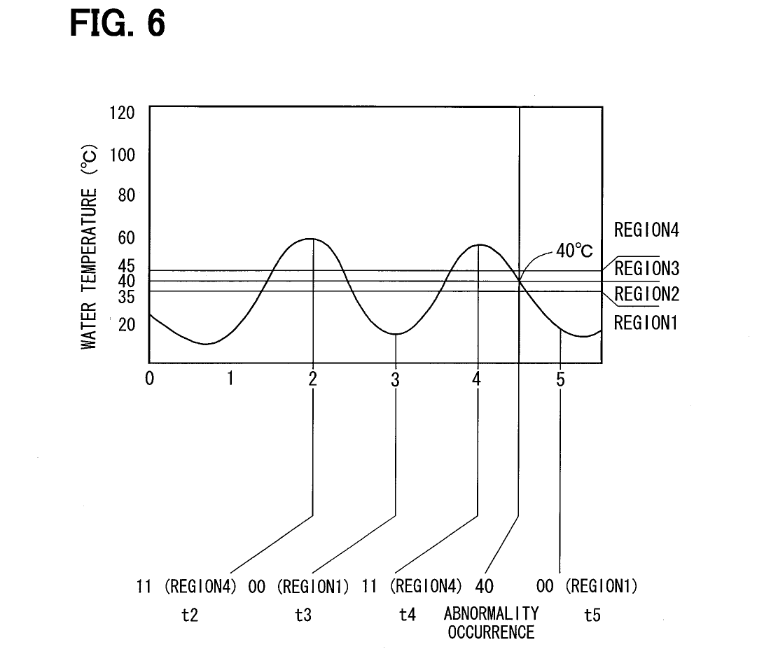

The storing section in the ECU 10 stores the time-series data values of the water temperature in the RAM 16 without simplification. When a vehicle abnormality occurs, the simplifying section divides the time-series data values of the water temperature into four regions by setting threshold values at a water temperature at the occurrence of the vehicle abnormality (40° C. in an example shown in FIG. 6), 35° C., and 45° C., which are ±5° C. from the water temperature at the occurrence of the vehicle abnormality. The simplifying section simplifies the data value of the water temperature by expressing a region where each of the data values of the water temperature belongs using 2 bits, and the simplified data values are stored in the EEPROM 22.

Although a center value of the data values of the water temperature is likely to change with the driving state of the vehicle, the data value changes little in a short time. For example, if a threshold value is fixed at 80° C. for determining before and after warm-up, the simplified data value of the water temperature except at the occurrence of the vehicle abnormality may belong to the same region.

Furthermore, in cases where the data values of the water temperature vibrate due to a sensor abnormality, if a threshold value is fixed, the simplified data values of the water temperature except at the occurrence of the vehicle abnormality may belong to the same region.

Even in cases where threshold values are fixed, when threshold values are finely set to increase the number of regions, a range of driving information whose change range is small or whose data value vibrates may change, and a time change may be reproduced from the simplified driving information. However, when the data value is finely divided, the data amount for explaining the region increases. As a result, it may be difficult to reduce the amount of stored data sufficiently.

Thus, in the present embodiment, the data values are divided into a plurality of regions on the basis of the data value at the occurrence of the vehicle and then the region where the data value belongs is expressed by a simplified data value. Accordingly, the driving information except at the occurrence of the vehicle abnormality can be simplified. In the present case, even if the data values change little in a short time or the data values vibrate as shown in FIG. 6, the simplified data value may belong to different regions. Thus, the change of the driving information on the time axis except at the occurrence of the vehicle abnormality can be reproduced.

With the exception of the water temperature, as described above, the ECU 10 may simplify the time-series data values of the driving information except at the occurrence of the vehicle abnormality when the ECU 10 stores the time-series data values in the RAM 16 or when the ECU 10 stores the time-series data value, which are stored in the RAM 16, in the EEPROM 22.

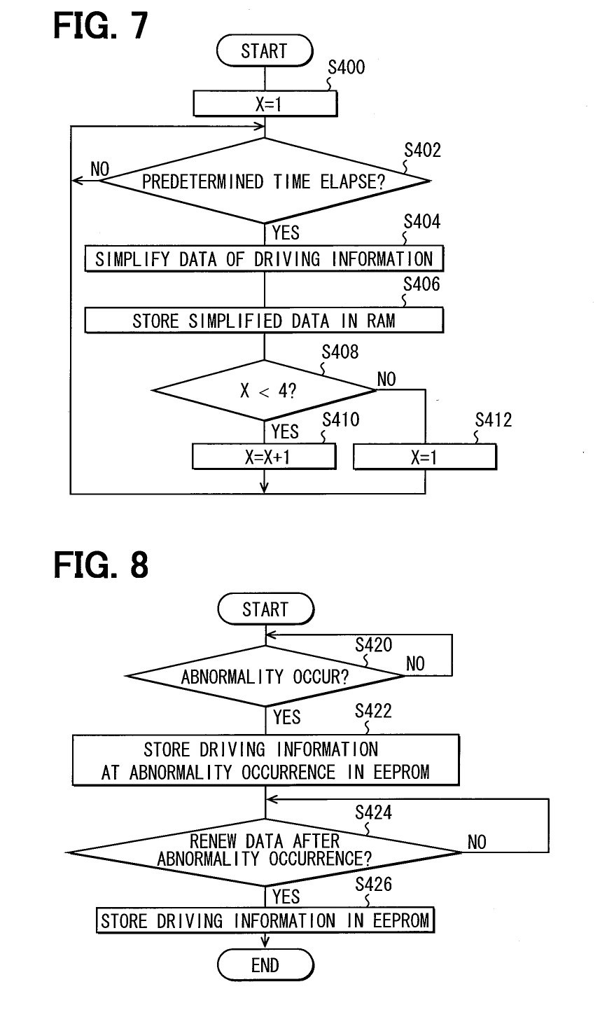

A first example of a driving information storing process will be described with reference to FIG. 7 and FIG. 8.

In a normal process shown in FIG. 7, the driving information is stored at predetermined intervals regardless of whether a vehicle abnormality occurs.

At S400, the ECU 10 sets 1 to an entry number X of the data values of the driving information. At S402, the ECU 10 determines whether a predetermined interval (e.g., 500 ms) elapses. If the predetermined interval elapses, which corresponds to “YES” at S402, the process proceeds to S404. The ECU 10 repeats the determination process at S402 until the predetermined time interval elapses. At S404, the ECU 10 simplifies the data values of the driving information with the above-described accuracy. At S406, the ECU 10 stores the simplified data values of the driving information in the RAM 16 and renew the simplified data values of the ring buffer DATA X.

At S408, the ECU 10 determines whether the entry number X is less than 4. When the entry number X is less than 4, which corresponds to “YES” at S408, the process proceeds to S410 where the ECU 10 adds 1 to the entry number X, and the process returns to S402. When the entry number X is equal to 4, which corresponds to “NO” at S408, the process proceeds to S412 where the ECU 10 sets 1 to the entry number X, and the process returns to S402.

Accordingly, 4 entries of the data values of the driving information are rewritten one by one from the oldest entry at intervals of 500 ms. The ECU 10 also constantly executes a process shown in FIG. 8 for storing the data value of the driving information at an occurrence of a vehicle abnormality.

When a vehicle abnormality occurs, which corresponds to “YES” at S420, the ECU 10 does not simplify the driving information at the occurrence of the vehicle abnormality and stores the driving information having the original data length in the EEPROM 22 at S422. After the occurrence of the vehicle abnormality, when the entry of the driving information is renewed in the ring buffer set in the RAM 16 in the process shown in FIG. 7, which corresponds to “YES” at S424, the ECU 10 stores the four-entry simplified data values of the driving information except at the occurrence of the vehicle abnormality, which are stored in the RAM 16, and the non-simplified data value of the driving information at the occurrence of the vehicle abnormality in the EEPROM 22 at S426.

In the first example of the driving information storing process shown in FIG. 7 and FIG. 8, the data values of the driving information are simplified by reducing the accuracy and the simplified data values of the driving information are stored in the RAM 16 in the normal process which is executed at the predetermined intervals regardless of an occurrence of a vehicle abnormality.

Accordingly, compared with cases where the data values of the driving information having the original data length are stored without simplification, the amount of stored data in the RAM 16 can be reduced. Furthermore, because the data values of the driving information except at the occurrence of the vehicle abnormality are stored in the EEPROM 22 with simplification, the amount of stored data in the EEPROM 22 can be reduced.

The data values of the driving information are simplified in the normal process executed at the predetermined intervals, and when a vehicle abnormality occurs, the simplified time-series driving information except at the occurrence of the vehicle abnormality are stored with the driving information at the occurrence of the vehicle abnormality. Thus, a processing load at the occurrence of the vehicle abnormality can be reduced.

In the driving information storing process shown in FIG. 7, the process at S404 may be performed by the simplifying section and the process at S406 may be performed by the storing section.

In the driving information storing process shown in FIG. 8, the process at S420 may be performed by the abnormality detecting section, and the processes at S422 and S426 may be performed by the storing section.

The RAM 16 may be provided as a storage portion and a volatile memory, and the EEPROM 22 may be provided as a storage portion and an information keeping memory that is rewritable and can keep the stored information even when driving of the vehicle stops.

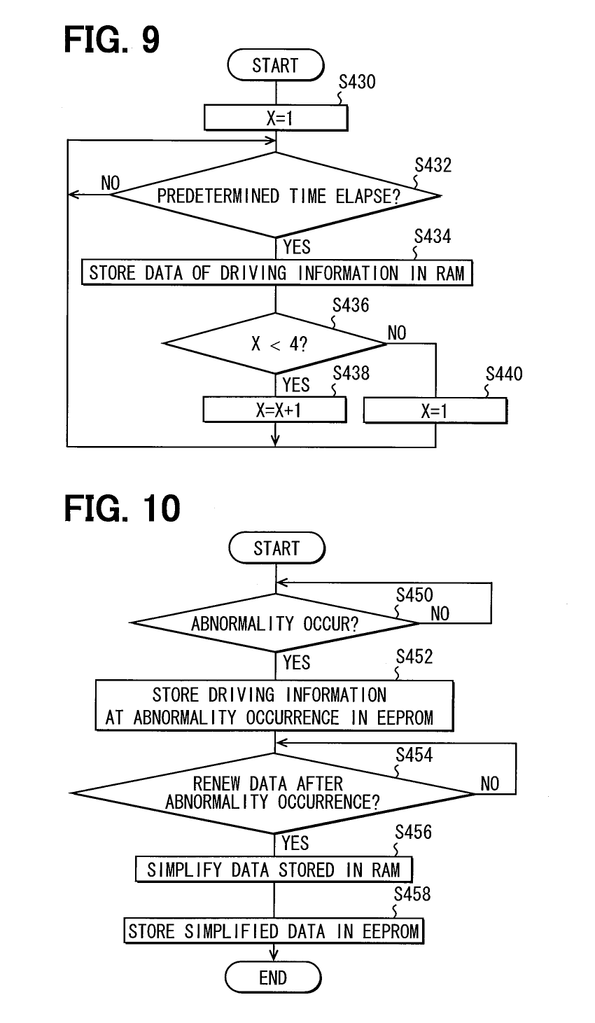

Next, a second example of a driving information storing process will be described with reference to FIG. 9 and FIG. 10.

In a normal process shown in FIG. 9, the data values of the driving information are stored at predetermined time intervals regardless of whether a vehicle abnormality occurs.

Processes at S430 to S440 in FIG. 9 are substantially similar to the processes at S400, S402, S406 to S412 in FIG. 7. However, in the driving information storing process in FIG. 9, the data values of the driving information are stored in the RAM 16 without simplification.

The ECU 10 also constantly executes a process shown in FIG. 10 for storing the data value of the driving information at an occurrence of a vehicle abnormality.

Processes at S450 to S454 and S458 in FIG. 10 are substantially similar to the processes at S420 to S426 in FIG. 8. However, at S456 in FIG. 10, the ECU 10 simplifies the data values of the driving information when the ECU 10 stores the data values of the driving information except at the occurrence of the vehicle abnormality, which are stored in the RAM 16, in the EEPROM 22. At S456, the ECU 10 simplifies the data values of the driving information with accuracy depending on each information item, such as the accelerator opening degree, the throttle opening degree, and the engine speed.

Furthermore, at S456, when the ECU 10 stores the data values of the vehicle information except at the occurrence of the vehicle abnormality, which are stored in the RAM 16, in the EEPROM 22 after simplification, as described above about the water temperature, the ECU 10 may divide the time-series data values into a plurality of regions on the basis of the data value at the occurrence of the vehicle abnormality, may simplify the data values by expressing the region where each of the data values belongs using N bits, where N is a number capable of indicating the number of regions, and may store the simplified data values in the EEPROM 22.

Contents of the data values of the driving information stored in the EEPROM 22 in the first example of the driving information storing process shown in FIG. 7 and FIG. 8 and contents of the data values of the driving information stored in the EEPROM 22 in the second example of the driving information storing process shown in FIG. 9 and FIG. 10 are similar to each other. In the second example of the driving information storing process shown in FIG. 9 and the FIG. 10, in the normal process executed at the predetermined intervals regardless of whether a vehicle abnormality occurs, the data values of the driving information having the original data length are stored in the RAM 16 without simplification. Accordingly, the processing load in the normal process can be reduced.

Also in the second example of the driving information storing process shown in FIG. 9 and FIG. 10, the data values of the driving information except at the occurrence of the vehicle abnormality are stored in the EEPROM 22 with simplification. Thus, the amount of stored data in the EEPROM 22 can be reduced.

In the second example of the driving information storing process shown in FIG. 9, the process at S434 may be performed by the storing section. In addition, in the second example of the driving information storing process shown in FIG. 10, the process at S450 may be performed by the abnormality detecting section, the processes at S452 and S458 may be performed by the storing section, and the process at S456 may be performed by the simplifying section.

In the second example of the driving information storing process shown in FIG. 9 and FIG. 10, in cases where the water temperature is stored as the driving information for analyzing the cause of the vehicle abnormality, the water temperature may be referred to a variable region information item. The first example of the driving information storing process shown in FIG. 7 and FIG. 8 or the second example of the driving information storing process shown in FIG. 9 and FIG. 10 may be repeated every time a vehicle abnormality occurs. In the present case, only the latest driving information may be stored in the EEPROM 22 by renewing the driving information, or the driving information for a predetermined number of times may be stored and the driving information may be renewed from the oldest driving information.

### Other Embodiments

In the above-described embodiment, as the data values of the driving information except at the occurrence of the vehicle abnormality, the data values of the driving information before and after the occurrence of the vehicle abnormality are simplified and are stored in the EEPROM 22. In another embodiment, only the data values of the driving information before the occurrence of the vehicle abnormality may be simplified and may be stored in the EEPROM 22.

In the above-described embodiment, the data values of the driving information are divided into a plurality of regions, and the region where each of the data values belongs is expressed using 1 bit or 2 bits for simplifying the driving information. The number of bits used for explaining the simplified data value is not limited to 1 bit or 2 bits. The driving information may be simplified using N bits, where N is a number capable of indicating the number of divided regions.

In the above-described embodiment, the driving information is stored in the EEPROM 22 for analyzing a cause of a vehicle abnormality. The driving information for analyzing a cause of a vehicle abnormality may be stored in other storage portion that can keep the stored information even after driving of the vehicle stops. For example, the driving information may be stored in the SRAM 20.

In the above-described embodiment, the amount of stored data in the EEPROM 22 that stores driving information for analyzing a cause of a vehicle abnormality can be reduced by simplifying the driving information except at an occurrence of a vehicle abnormality. In cases where the amount of stored data in the EEPROM 22 is not necessary to be reduced, when the data values of the driving information except at an occurrence of a vehicle abnormality are simplified, the vehicle abnormality can be analyzed more specifically by shortening intervals of the time-series data values of the driving information to increase the number of storing points or by increasing items of the driving information to be stored.

The electronic control unit according to the present disclosure may be applied to a vehicle whose driving source is an internal-combustion engine, such as gasoline engine and diesel engine, a hybrid vehicle using an internal-combustion engine with a motor, or an electronic vehicle whose driving source is a motor.

The control program in the ECU 10 may provide functions of the abnormality detecting section, the storing section, and the simplifying section, or at least one of the abnormality detecting section, the storing section, and the simplifying section may be provided by hardware.

While the present disclosure has been described with reference to the foregoing embodiments, it is to be understood that the disclosure is not limited to the embodiments and constructions. The present disclosure is intended to cover various modification and equivalent arrangements.

What is claimed is:

1. An electronic control unit comprising:
an abnormality detecting section that detects an occurrence of a vehicle abnormality;
a storage portion that stores driving information of a vehicle;
a simplifying section that simplifies time-series data values of the driving information before the occurrence of the vehicle abnormality by reducing an accuracy of the time-series data values of the driving information and that does not simplify a data value of the driving information at the occurrence of the vehicle abnormality; and
a storing section that stores the data value of the driving information at the occurrence of the vehicle abnormality, which is not simplified by the simplifying section, and the time-series data values of the driving information before the occurrence of the vehicle abnormality, which are simplified by the simplifying section, in the storage portion.

2. The electronic control unit according to claim 1,
wherein the simplifying section also simplifies time-series data values of the driving information after the occurrence of the abnormality by reducing the accuracy of the time-series data values of the driving information, and
wherein the storing section also stores the time-series data values of the driving information after the occurrence of the vehicle abnormality, which are simplified by the simplifying section, in the storage portion.

3. The electronic control unit according to claim 1,
wherein the driving information of the vehicle includes a plurality of information items,
wherein the time-series data values of each of the information items are divided into a plurality of regions, and
wherein the simplifying section simplifies the time-series data values of each of the information items by expressing a region where each of the time-series data values belongs.

4. The electronic control unit according to claim 3,
wherein the time-series data values of one of the information items are divided into two regions, and
wherein the simplifying section simplifies the time-series data values of the one of the information items by expressing a region where each of the time-series data values belongs using 1 bit.

5. The electronic control unit according to claim 3,
wherein the time-series data values of one of the information items are divided into three or more regions, and
wherein the simplifying section simplifies the time-series data values of the one of the information items by expressing a region where each of the time-series data values belongs using N bits, where N is a number capable of indicating the number of regions.

6. The electronic control unit according to claim 1,
wherein the storage portion includes a volatile memory and an information keeping memory that keeps stored information even after driving of the vehicle stops,
wherein the storing section stores the time-series data values of the driving information before the occurrence of the vehicle abnormality, which are simplified by the simplifying section, in the volatile memory, and
wherein when the abnormality detecting section detects the occurrence of the vehicle abnormality, the storing section stores the time-series data values of the driving information before the occurrence of the vehicle abnormality, which are simplified by the simplifying section and are stored in the volatile memory, and the data value of the driving information at the occurrence of the abnormality in the information keeping memory.

7. The electronic control unit according to claim 1,
wherein the storage portion includes a volatile memory and an information keeping memory that keeps stored information even after driving of the vehicle stops,
wherein the storing section stores the time-series data values of the driving information before the occurrence of the vehicle abnormality, which are not simplified by the simplifying section, in the volatile memory, and
wherein when the abnormality detecting section detects the occurrence of the vehicle abnormality, the simplifying section simplifies the time-series data values of the driving information before the occurrence of the vehicle abnormality, which are stored in the volatile memory, and the storing section stores the time-series data values of the driving information before the occurrence of the vehicle abnormality, which are simplified by the simplifying section, and the data value of the driving information at the occurrence of the abnormality in the information keeping memory.

8. The electronic control unit according to claim 6,
wherein the driving information includes a variable region information item,
wherein the storing section stores the time-series data values of the variable region information item before the occurrence of the vehicle abnormality, which are not simplified by the simplifying section, in the volatile memory, and
wherein when the abnormality detecting section detects the occurrence of the vehicle abnormality, the simplifying section divides the time-series data values of the variable region information item before the occurrence of the abnormality, which are stored in the volatile memory, into a plurality of regions on the basis of a data value of the variable region information item at the occurrence of the abnormality and simplifies the time-series data values of the variable region information item by expressing a region where each of the time-series data values belongs, and the storing section stores the time-series data values of the variable region information item before the occurrence of the vehicle abnormality, which are simplified by the simplifying section, and the data value of the variable region information item at the occurrence of the abnormality in the information keeping memory.

9. The electronic control unit according to claim 8,
wherein the variable region information item includes a water temperature.

10. The electronic control unit according to claim 7,
wherein the driving information includes a variable region information item,
wherein the storing section stores the time-series data values of the variable region information item before the occurrence of the vehicle abnormality, which are not simplified by the simplifying section, in the volatile memory, and
wherein when the abnormality detecting section detects the occurrence of the vehicle abnormality, the simplifying section divides the time-series data values of the variable region information item before the occurrence of the abnormality, which are stored in the volatile memory, into a plurality of regions on the basis of a data value of the variable region information item at the occurrence of the abnormality and simplifies the time-series data values of the variable region information item by expressing a region where each of the time-series data values belongs, and the storing section stores the time-series data values of the variable region information item before the occurrence of the vehicle abnormality, which are simplified by the simplifying section, and the data value of the variable region information item at the occurrence of the abnormality in the information keeping memory.

11. The electronic control unit according to claim 10,
wherein the variable region information item includes a water temperature.
